(19) United States
(12) Patent Application Publication
(10) Pub. No.: US 2013/0013731 A1
(43) Pub. Date: Jan. 10, 2013

(54) DEVICES, SYSTEMS, AND METHODS FOR TRANSMITTING A MESSAGE

(76) Inventors: Bradley Richard Ree, Cumming, GA (US); Ajay Pal Grewal, Rochester, NY (US)

(21) Appl. No.: 13/179,243

(22) Filed: Jul. 8, 2011

(51) Int. Cl. G06F 15/16

(52) U.S. Cl. 709/217

(57) ABSTRACT

A device for use in transmitting a message includes a memory device including an application layer that includes a constrained application protocol and a processor coupled to the memory device. The processor is programmed to identify a message to be transmitted through a data link to at least one other device within a network, determine a quality of the data link, and determine a segment size based on the data link quality. The processor is also programmed to execute instructions within the application layer to form at least one message segment from the message such that a size of the at least one message segment is equal to the segment size. The device also includes a communication device configured to transmit the at least one message segment to the at least one other device.

### BACKGROUND OF THE INVENTION

The present application relates generally to communication devices and, more particularly, to devices, systems, and methods for use in transmitting a message.

Some known power utilities utilize so-called “smart grid” or Advanced Metering Infrastructure (AMI) power networks. Using an AMI network, a power utility may communicate with individual loads within a customer's premises and selectively reduce power consumption during peak usage periods. As such, a power utility may reduce power to low priority loads, while maintaining power to high priority loads.

Moreover, in known AMI networks, the utility communicates with electricity meters that are coupled to the loads within the customer's premises. The electricity meters may facilitate communication between the utility and the loads, for example, by transmitting messages between the utility and the loads. Such communication may be via power line communication protocol or an internet protocol, such as a transmission control protocol, for example. However, such protocols and/or transmission mechanisms may be unsuitable for devices within a home area network or within portions of the AMI network that require low power consumption. Moreover, such protocols and/or transmission mechanisms may be unsuitable for devices positioned within a mesh network.

### BRIEF DESCRIPTION OF THE INVENTION

In one embodiment, a device for use in transmitting a message is provided that includes a memory device including an application layer that includes a constrained application protocol and a processor coupled to the memory device. The processor is programmed to identify a message to be transmitted through a data link to at least one other device within a network, determine a quality of the data link, and determine a segment size based on the data link quality. The processor is also programmed to execute instructions within the application layer to form at least one message segment from the message such that a size of the at least one message segment is equal to the segment size. The device also includes a communication device configured to transmit the at least one message segment to the at least one other device.

In another embodiment, a communication system is provided that includes a first device and a second device coupled to the first device by a data link to form a network. The first device includes a memory device including an application layer that includes a constrained application protocol, and a processor coupled to the memory device. The processor is programmed to identify a message to be transmitted through the data link to the second device, determine a quality of the data link, and determine a segment size based on the data link quality. The processor is also programmed to execute instructions within the application layer to form at least one message segment from the message such that a size of the at least one message segment is equal to the segment size. The first device also includes a communication device configured to transmit the at least one message segment to the second device.

In yet another embodiment, a method for transmitting a message from a first device to a second device is provided. The method includes identifying a message to be transmitted from the first device to the second device through a data link, determining a quality of the data link, and determining a segment size based on the data link quality. The method also includes executing instructions within an application layer that includes a constrained application protocol to form at least one message segment from the message such that a size of the at least one message segment is equal to the segment size, and transmitting the at least one message segment to the second device.

### BRIEF DESCRIPTION OF THE DRAWINGS

FIG. 1 is a block diagram of an exemplary communication system.

FIG. 2 is a block diagram of an exemplary device that may be used with the communication system shown in FIG. 1.

FIG. 3 is a block diagram of an exemplary network protocol stack that may be used with the device shown in FIG. 2.

FIG. 4 is a block diagram of an exemplary message that may be transmitted using the network protocol stack shown in FIG. 3.

FIG. 5 is a flow diagram of an exemplary method for transmitting a message that may be used with the device shown in FIG. 2 and/or the network protocol stack shown in FIG. 3.

### DETAILED DESCRIPTION OF THE INVENTION

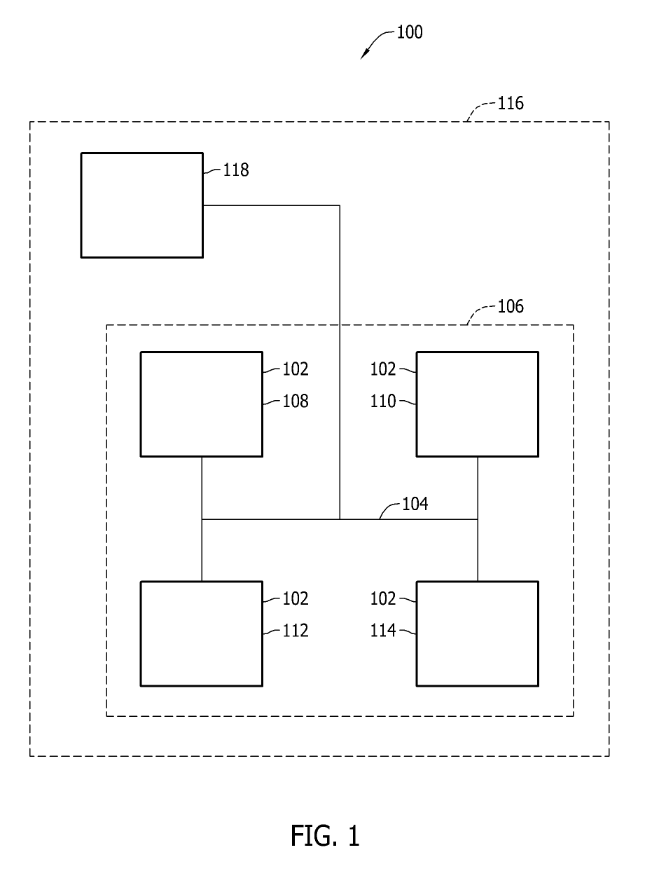

FIG. 1 illustrates an exemplary communication system 100. In the exemplary embodiment, system 100 includes a plurality of devices 102 coupled together via a data link 104 to form a network 106. As shown in FIG. 1, for example, network 106 includes a first device 108, a second device 110, a third device 112, and a fourth device 114 that are coupled together via data link 104. While FIG. 1 illustrates four devices 102, it should be recognized that any number of devices 102 may be coupled together and/or included within network 106 to enable system 100 to function as described herein.

In the exemplary embodiment, network 106 is a mesh network 106 that enables data to be transmitted between devices 102 via a plurality of pathways, routes, and/or devices (not shown). As used herein, a “mesh network” is a network in which devices within the network may operate as a destination for data, an originator of data, and a repeater or relay of data to forward data from an originating device to a destination device. Alternatively, network 106 may be any other network that enables system 100 to function as described herein. Moreover, in the exemplary embodiment, network 106 is part of an advanced metering infrastructure (AMI) network 116. In the exemplary embodiment, AMI network 116 includes at least one computer 118 that transmits data to, and/or receives data from, a plurality of power systems and/or devices, such as devices 102. Additionally or alternatively, network 106 is a home area network (HAN) 106 that includes a plurality of devices 102 positioned within a residence or another building or location.

In the exemplary embodiment, computer 118 includes at least one processor that controls and/or monitors an operation of AMI network 116. The processor includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.”

Moreover, in the exemplary embodiment, devices 102 are electricity meters 102 that measure and/or detect an amount of electricity received and/or provided (hereinafter referred to as “electricity measurement data”) to one or more loads (not shown) coupled to meters 102. As described more fully herein, meters 102 transmit data, such as electricity measurement data, to, and/or receive data from, other devices or systems within network 106 and/or AMI network 116. Alternatively, devices 102 may be, but are not limited to only being, one or more of a smartphone, a personal data assistant (PDA), a laptop computer, a desktop computer, a server, a touchpad, a network router, a network switch, and/or any other device that enables system 100 to function as described herein. In one embodiment, devices 102 may additionally or alternatively include one or more load controllers, programmable thermostats, and/or “smart” appliances. In such an embodiment, devices 102 form at least a part of HAN 106.

In the exemplary embodiment, data link 104 is a wireless data connection that wirelessly transmits data between devices 102. Alternatively, data link 104 includes at least one conductor or bus (not shown) that transmits data between devices 102, and/or any other data connection that enables system 100 to function as described herein. Moreover, in the exemplary embodiment, data link 104 uses a network protocol stack that includes a constrained application (CoAP) protocol layer and a user datagram protocol (UDP) layer (none shown in FIG. 1) for transmitting and receiving data, such as one or more packets or messages, between devices 102 and/or other devices or components of network 106. In the exemplary embodiment, a CoAP protocol is a web transfer protocol for use with constrained networks and nodes for machine-to-machine applications such as smart energy and building automation. Moreover, CoAP may provide an interaction model between application end-points and supports multicast while providing low message overhead. One exemplary CoAP protocol is described in the Constrained Application Protocol (CoAP) draft-ietf-core-coap-03 specification available at http://tools.ietf.org/html/draft-ietf-core-coap-03.

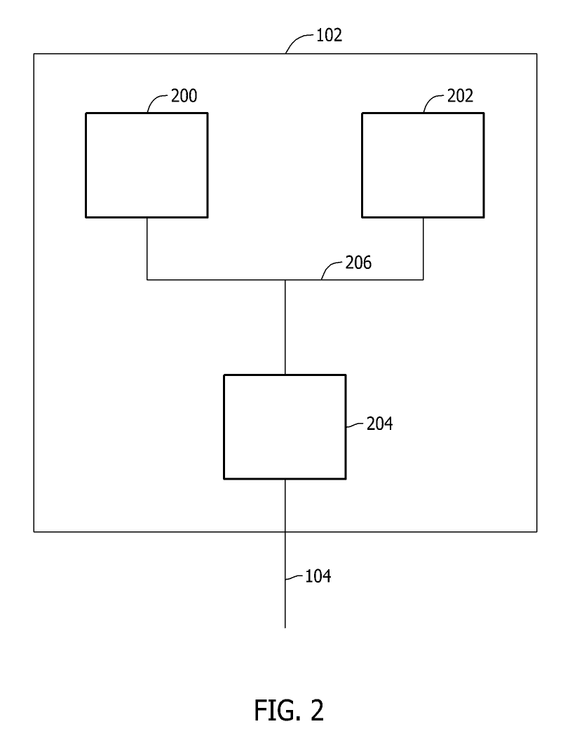

FIG. 2 is a block diagram of an exemplary device 102 that may be used with system 100 (shown in FIG. 1). In the exemplary embodiment, device 102 includes a processor 200, a memory device 202, and a communication device 204 that are coupled together via at least one bus 206.

In the exemplary embodiment, processor 200 includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.”

Memory device 202, in the exemplary embodiment, includes a computer readable medium, such as, without limitation, random access memory (RAM), flash memory, a hard disk drive, a solid state drive, a diskette, a flash drive, a compact disc, a digital video disc, and/or any suitable memory. In the exemplary embodiment, memory device 202 includes data and/or instructions that are executable by processor 200 (i.e., processor 200 is programmed by the instructions) to enable processor 200 to perform the functions described herein. As described more fully herein, in the exemplary embodiment, at least a portion of the instructions are embodied within a plurality of layers of a network protocol stack (not shown in FIG. 2).

In the exemplary embodiment, communication device 204 includes a radio frequency antenna (not shown) that transmits data to mesh network 106 and that receives data from mesh network 106 using a suitable wireless protocol, as described more fully herein. Alternatively, communication device 204 may include, without limitation, any other suitable antenna, a network interface controller (NIC), a network adapter, a transceiver, and/or any other device that enables device 204 to operate as described herein. Communication device 204 couples device 102 to data link 104 such that device 102 may transmit data to, or receive data from, other devices within network 106. In one embodiment, communication device 204 includes at least one computer readable medium (not shown), such as flash memory, random access memory, and/or any other computer readable medium that enables communication device 204 to function as described herein.

During operation, in the exemplary embodiment, computer 118 transmits power management messages and/or other data to devices 102. The power management messages are transmitted through network 106 to a destination device 102 via other devices 102 and/or via data link 104. In the exemplary embodiment, because network 106 is a mesh network 106, devices 102 respond to the power management messages by transmitting data to computer 118 via data link 104 and/or via other devices 102. More specifically, in the exemplary embodiment, devices 102 are electricity meters 102 that measure or detect an amount of electricity used by at least one load (not shown) that is coupled to a respective device 102. Devices 102 transmit measurements representative of the electricity used by the loads, i.e., electricity measurement data, to computer 118 for use in monitoring the electricity used within AMI network 116.

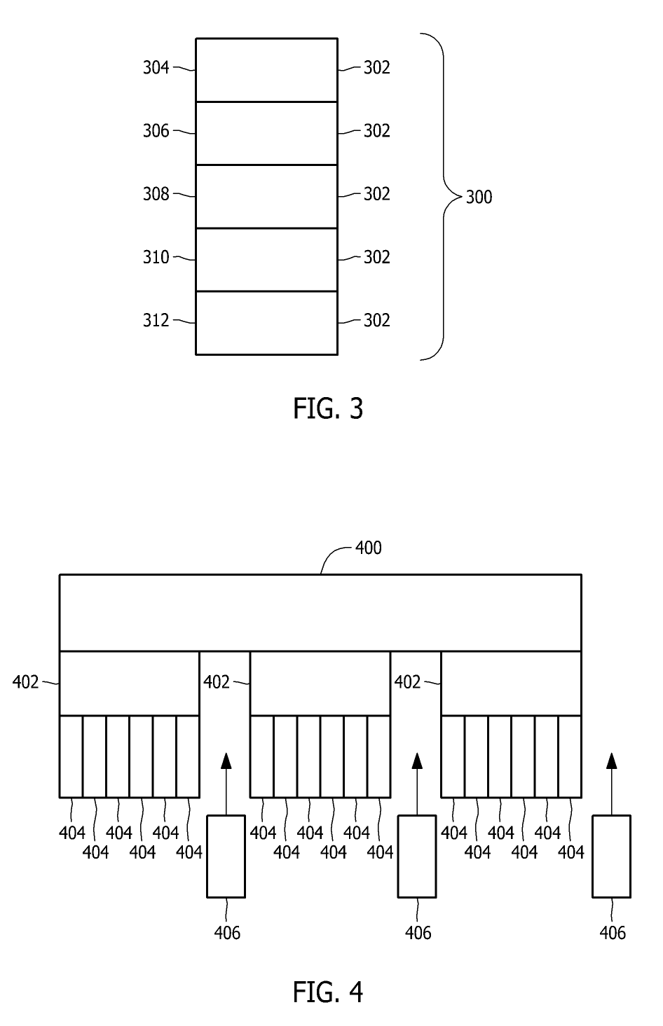

FIG. 3 is a block diagram of an exemplary network protocol stack 300 that may be used with device 102 (shown in FIG. 1). FIG. 4 is a block diagram of an exemplary message 400 that may be transmitted using stack 300. In the exemplary embodiment, stack 300 is embodied within memory device 202 and/or within communication device 204 (both shown in FIG. 2). More specifically, in the exemplary embodiment, stack 300 includes a plurality of protocol layers 302 that are embodied within memory device 202 and/or within communication device 204. In the exemplary embodiment, layers 302 include an application layer 304, a transport layer 306 coupled to application layer 304, a network layer 308 coupled to transport layer 306, a data link layer 310 coupled to network layer 308, and a physical layer 312 coupled to data link layer 310. As used herein, the term “layer” represents a software, firmware, and/or hardware based grouping of instructions, data, and/or components that perform an identified function.

In the exemplary embodiment, application layer 304 is embodied within memory device 202. More specifically, in the exemplary embodiment, application layer 304 includes a constrained application protocol (CoAP) that identifies a message 400, such as a power management message 400 and/or a message 400 including electricity measurement data, to be transmitted to another device 102 and determines a message segment size (hereinafter referred to as a “segment size”) for message 400. In the exemplary embodiment, the segment size represents a number of bytes to be included within a message segment 402. Application layer 304 forms at least one message segment 402 from message 400 based on the segment size. If a size of message 400 is greater than the segment size, message 400 is partitioned into a plurality of message segments 402. For example, if the size of message 400 is 1010 bytes, and the segment size is 100 bytes, application layer 304 forms 10 message segments 402 of 100 bytes each and an 11^{th} message segment 402 of 10 bytes. However, if the size of message 400 is 100 bytes and the segment size is 100 bytes, application layer 304 forms a single message segment 402 of 100 bytes. It should be recognized that the examples herein may not reflect additional bytes of data that may be added to message 400 and/or to segment 402 as a result of header data or any other control and/or routing data. Moreover, as described more fully herein, application layer 304 determines, or adjusts, the segment size based on a determined quality of data link 104 and/or a determined error rate of data link 104.

Transport layer 306, in the exemplary embodiment, is coupled to application layer 304. More specifically, in the exemplary embodiment, transport layer 306 includes a user datagram protocol (UDP). In the exemplary embodiment, a network layer 308 is coupled to transport layer 306. In the exemplary embodiment, network layer 308 is an Internet Protocol (IP), such as an IPv6 layer 308. Moreover, in the exemplary embodiment, transport layer 306 and network layer 308 are embodied within memory device 202.

A data link layer 310, in the exemplary embodiment, is coupled to network layer 308. In the exemplary embodiment, data link layer 310 includes an IPv6 over Low power Wireless Personal Area Network (“6LoWPAN”) protocol. Data link layer 310 forms and/or partitions message segments 402 into at least one message fragment 404 based on a determined message fragment size (hereinafter referred to as a “fragment size”). In the exemplary embodiment, the fragment size is determined (for example, by processor 200) to be a maximum transmission unit (MTU) of data link 104. For example, if the segment size is 100 bytes, and the fragment size is 10 bytes, data link layer 310 may form 10 message fragments 404 of 10 bytes each. However, if the segment size is 100 bytes and the fragment size is 100 bytes, data link layer 310 may form a single message segment 402 of 100 bytes. It should be recognized that the examples herein may not reflect additional bytes of data that may be added to message segment 402 and/or to message fragment 404 as a result of header data or any other control and/or routing data. Alternatively, the fragment size may be determined to be any other size that enables device 102 to function as described herein. As such, as the segment size and/or the fragment size is adjusted, a number of message fragments 404 per message segment 402 changes accordingly (i.e., the number of message fragments 404 formed from each message segment 402 is changed).

Moreover, in the exemplary embodiment, a physical layer 312 is coupled to data link layer 310. In the exemplary embodiment, data link layer 310 and physical layer 312 are embodied within communication device 204. Alternatively, any layer 302 may be embodied within any component of device 102 that enables device 102 to function as described herein. In the exemplary embodiment, physical layer 312 is coupled in data communication with a radio frequency antenna or a radio transceiver within communication device 204 that transmits data to, and receives data from, a mesh network 106 (i.e., to and from a wireless data link 104 established between devices 102 of a mesh network 106). Physical layer 312 transmits signals representative of message fragments 404 and/or message segments 402 to a remote device 102 within network 106, and receives signals representative of acknowledgement messages 406 from remote device 102 when remote device 102 receives message fragments 404 of each message segment 402.

In an alternative embodiment, any layer 302 of network protocol stack 300 may be adapted to transmit message 400 to a remote device 102 via any other protocol or transmission medium. For example, physical layer 312 and data link layer 310 may be configured to transmit message 400 via a wired data link 104 (i.e., via one or more conductors or busses) rather than wirelessly.

During operation, device 102, such as first device 108, identifies a message 400 to be transmitted to a remote device 102, such as second device 110. First device 108 uses network protocol stack 300 to transmit message 400 to second device 110. More specifically, in the exemplary embodiment, application layer 304 determines a segment size to be used for message 400 and partitions message 400 into message segments 402 based on the determined message segment size. Application layer 304 transmits message segments 402 to transport layer 306, and transport layer 306 encapsulates and/or adds UDP header data to each message segment 402. Transport layer 306 transmits message segments 402 to network layer 308 for encapsulation and/or for the addition of IP header information to segments 402. Network layer 308 transmits segments 402 to data link layer 310. In the exemplary embodiment, data link layer 310 forms at least one message fragment 404 from each message segment 402 and encapsulates and/or adds header data to each fragment 404. Data link layer 310 transmits fragments 404 to physical layer 312 for transmission to second device 110 via data link 104.

In the exemplary embodiment, second device 110 receives fragments 404 and transmits acknowledgement message 406 to first device 108 after second device 110 receives all message fragments 404 of message segment 402. If first device 108 does not receive an acknowledgement message 406 in response to a transmitted message segment 402 within a predetermined amount of time, processor 200 of first device 108 determines that a communication error has occurred. In the exemplary embodiment, a communication error is an error transmitting and/or receiving a message 400 and/or an error transmitting and/or receiving an acknowledgement message 406, such as when one or more portions of message 400 (i.e., one or more portions of message fragments 404 and/or message segments 402 of message 400) are not transmitted or received as expected. For example, a communication error may include a missing acknowledgement message 406, a checksum error of one or more portions of message 400 or of acknowledgement message 406, and/or a data corruption of one or more portions of message 400 or of acknowledgement message 406.

Processor 200 stores a record of the communication error in memory device 202, and retransmits message fragments 404 of message segment 402 to second device 110. Moreover, processor 200 adjusts, such as continuously or periodically adjusts, the segment size of message segments 402 to be transmitted based on a determined quality of data link 104, e.g., based on a number of communication errors identified during a predetermined amount of time (hereinafter referred to as a “communication error rate”), based on a strength of signals within network 106, based on a congestion of network 106, and/or based on a memory (e.g., buffer) size or availability of memory space within devices 102. Alternatively or additionally, processor 200 may determine that a communication error occurred if acknowledgement message 406 received from second device 110 is corrupted and/or if acknowledgement message 406 is irrational (e.g., one or more portions of acknowledgement message 406 are determined to be invalid or erroneous based on one or more characteristics of transmitted message segment 402).

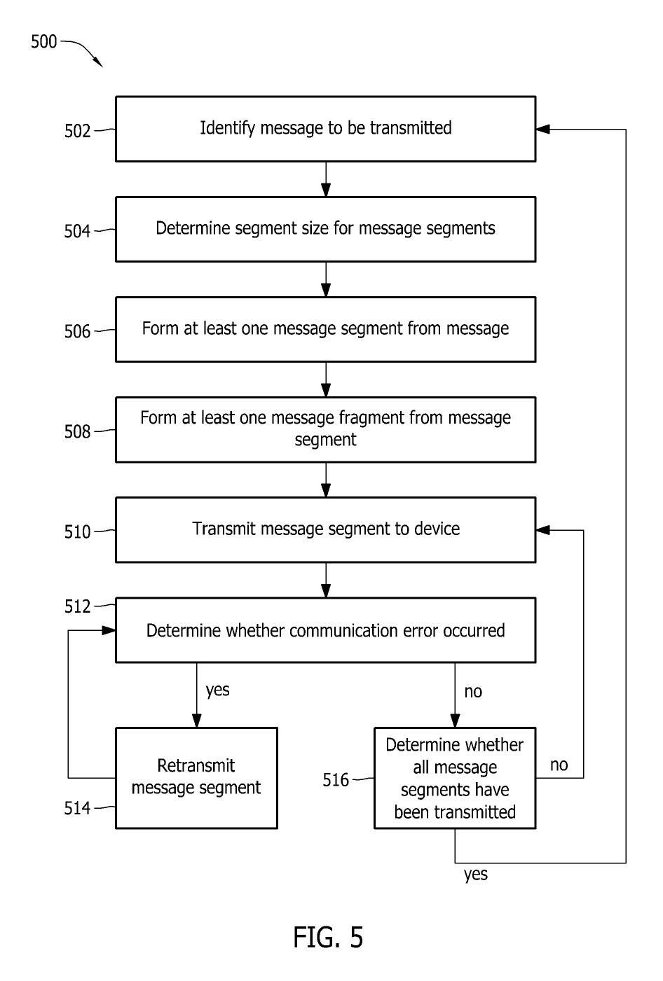

FIG. 5 is a flow diagram of an exemplary method 500 for transmitting a message that may be used with device 102 and/or system 100 (shown in FIG. 1). In the exemplary embodiment, method 500 is embodied within a plurality of instructions stored within memory device 202 and/or within communication device 204 (both shown in FIG. 2). Moreover, in the exemplary embodiment, processor 200 (shown in FIG. 2) executes the instructions to perform the functions described herein and/or to cause the functions described herein to be performed. More specifically, in the exemplary embodiment, processor 200 of first device 108 (shown in FIG. 1) uses network protocol stack 300 (shown in FIG. 3) to transmit a message 400 (shown in FIG. 4) to a second device 110 (shown in FIG. 1).

In the exemplary embodiment, processor 200 identifies 502 a message 400 to be transmitted to second device 110 and transmits message 400 to application layer 304. In the exemplary embodiment, processor 200 accesses and/or executes application layer 304 to determine 504 a segment size for message segments 402 (shown in FIG. 4). More specifically, processor 200 determines 504 the segment size based on a determined quality of data link 104 (shown in FIG. 1). The quality of data link 104 is based on a number of communication errors received within a predetermined amount of time (i.e., the “communication error rate”).

In the exemplary embodiment, the communication error rate is compared to an error rate threshold. If the communication error rate exceeds the error rate threshold, processor 200 reduces the segment size. In such a situation, the high communication error rate requires more message segments 402 to be retransmitted to second device 110 as compared to a situation where the communication error rate does not exceed the error rate threshold. Accordingly, reducing the segment size facilitates reducing a bandwidth used by first device 108 in retransmitting message segments 402. Moreover, in the exemplary embodiment, if the communication error rate is lower than the error rate threshold, processor 200 increases the segment size. In such a situation, increasing the segment size facilitates increasing an efficiency and/or a data transmission rate of first device 108, as a number of acknowledgement messages 406 transmitted by second device 110 is reduced. If the communication error rate is equal to the error rate threshold, processor 200 maintains the segment size at its previous value.

Moreover, in the exemplary embodiment, processor 200 (e.g., during execution of application layer 304) maintains the segment size within predetermined limits. In the exemplary embodiment, if the reduction of the segment size would cause the segment size to be lower than a predetermined minimum segment size, processor 200 sets the segment size to be equal to the minimum segment size. Moreover, if the increase of the segment size would cause the segment size to be higher than a predetermined maximum segment size, processor 200 sets the segment size to be equal to the maximum segment size. In the exemplary embodiment, the maximum segment size is equal to a size of message 400. Alternatively, the maximum segment size is any other size or value that enables method 500 to function as described herein. Moreover, in the exemplary embodiment, the minimum segment size is equal to a maximum transmission unit (MTU) of data link 104. Alternatively, the minimum segment size is any other size or value that enables method 500 to function as described herein.

In the exemplary embodiment, processor 200 forms 506 at least one message segment 402 from message 400 based on the determined 504 segment size. Moreover, processor 200 forms 508 at least one message fragment 404 (shown in FIG. 4) from each message segment 402 using, for example, data link layer 310 (shown in FIG. 3). Processor 200 transmits 510 message segment 402 to second device 110 by transmitting each message fragment 404 of message segment 402 to second device 110.

Processor 200, in the exemplary embodiment, determines 512 whether a communication error occurred by monitoring acknowledgement messages 406 (shown in FIG. 4) received from second device 110. More specifically, processor 200 detects or determines that a communication error has occurred if an acknowledgement message 406 is not received from second device 110 within a predetermined amount of time after all message fragments 404 of a message segment 402 have been transmitted to second device 110. Additionally or alternatively, processor 200 detects or determines 512 that a communication error has occurred if an acknowledgement message 406 is corrupted and/or irrational, as described more fully above.

If a communication error has occurred, processor 200 retransmits 514 message segment 402 (i.e., all message fragments 404 of message segment 402) and determines 512 whether a communication error occurred with the retransmitted message segment 402. If no communication error occurred, processor 200 determines 516 whether all message segments 402 of message 400 have been transmitted to second device 110. If not all message segments 402 have been transmitted, processor 200 transmits 510 the next message segment 402 of message 400 to second device 110. If processor determines 516 that all message segments 402 of message 400 have been transmitted (i.e., the transmission of message has completed), processor 200 returns to identifying 502 a new message 400 to be transmitted. Moreover, processor 200 adjusts the segment size of subsequent messages 400 based on the communication errors detected and/or based on the communication error rate.

Accordingly, processor 200 uses network protocol stack 300 to automatically adjust the segment size of messages to be transmitted based on the determined quality of data link 104 and/or based on the detected communication error rate of messages 400 and/or message segments 402 transmitted from first device 108 to second device 110 via data link 104. As such, a data transfer rate and/or an efficiency of first device 108 and/or of data link 104 is facilitated to be increased as compared to known systems that use a fixed segment size.

A technical effect of the systems and methods described herein includes at least one of (a) identifying a message to be transmitted from a first device to a second device through a data link; (b) determining a quality of a data link; (c) determining a segment size based on a data link quality; (d) executing instructions within an application layer that includes a constrained application protocol (CoAP) to form at least one message segment from a message such that a size of the at least one message segment is equal to a determined segment size; and (e) transmitting at least one message segment to a second device.

The above-described embodiments provide an efficient and cost-effective device that includes a processor that transmits messages to a remote device via a constrained application protocol. The processor executes instructions within a network protocol stack to determine a segment size based on a determined quality of a data link. The processor identifies a message to be transmitted to the remote device, and forms at least one message segment from the message based on the segment size. Each message segment is transmitted to the remote device via the data link. The processor retransmits the message segment if a communication error occurred for that segment. Moreover, the processor adjusts the segment size based on a communication error rate and/or a quality of the data link. As such, the device facilitates increasing an efficiency and/or a rate of data transmission via the data link.

Exemplary embodiments of a system, a device, and a method for use in transmitting a message are described above in detail. The system, device, and method are not limited to the specific embodiments described herein, but rather, components of the system and/or device and/or steps of the method may be utilized independently and separately from other components and/or steps described herein. For example, the device may also be used in combination with other network or measurement systems and methods, and is not limited to practice with only the AMI network as described herein. Rather, the exemplary embodiment can be implemented and utilized in connection with many other network or measurement applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for use in transmitting a message, said device comprising:
a memory device comprising an application layer that comprises a constrained application protocol (CoAP);
a processor coupled to said memory device and programmed to:
identify a message to be transmitted through a data link to at least one other device within a network;
determine a quality of the data link;
determine a segment size based on the data link quality; and
execute instructions within said application layer to form at least one message segment from the message such that a size of the at least one message segment is equal to the segment size; and
a communication device configured to transmit the at least one message segment to the at least one other device.

2. A device in accordance with claim 1, wherein said memory device further comprises a transport layer coupled to said application layer, said transport layer comprises a user datagram protocol (UDP).

3. A device in accordance with claim 1, wherein said memory device further comprises a data link layer comprising an IPv6 over Low power Wireless Personal Area Network (6LoWPAN) protocol.

4. A device in accordance with claim 1, wherein the network is a mesh network, said device is part of the mesh network.

5. A device in accordance with claim 1, wherein the network is part of an advanced metering infrastructure (AMI) network, and wherein said device is part of the AMI network.

6. A device in accordance with claim 1, wherein said device is an electricity meter within an AMI network, said device is configured to include electricity measurement data within the message.

7. A device in accordance with claim 1, wherein the network is a home area network, said device is part of the home area network.

8. A device in accordance with claim 1, wherein said processor is programmed to determine the quality of the data link based on a number of communication errors detected within a predetermined amount of time.

9. A communication system comprising:
a first device; and
a second device coupled to said first device by a data link to form a network,
said first device comprising:
a memory device comprising an application layer that comprises a constrained application protocol (CoAP);
a processor coupled to said memory device and programmed to:
identify a message to be transmitted through the data link to said second device;
determine a quality of the data link;
determine a segment size based on the data link quality; and
execute instructions within said application layer to form at least one message segment from the message such that a size of the at least one message segment is equal to the segment size; and
a communication device configured to transmit the at least one message segment to said second device.

10. A communication system in accordance with claim 9, wherein said memory device further comprises a data link layer coupled to said application layer, said data link layer comprises a user datagram protocol (UDP).

11. A communication system in accordance with claim 9, wherein the network is a mesh network, said first device is part of the mesh network.

12. A communication system in accordance with claim 9, wherein said first device is an electricity meter within an advanced metering infrastructure (AMI) network.

13. A communication system in accordance with claim 9, wherein said processor is programmed to determine the quality of the data link based on a number of communication errors detected within a predetermined amount of time.

14. A communication system in accordance with claim 9, wherein said processor is further programmed to receive at least one acknowledgement message from said second device when said second device receives the message.

15. A method for transmitting a message from a first device to a second device, said method comprising:
identifying a message to be transmitted from the first device to the second device through a data link;
determining a quality of the data link;
determining a segment size based on the data link quality;
executing instructions within an application layer that includes a constrained application protocol (CoAP) to form at least one message segment from the message such that a size of the at least one message segment is equal to the segment size; and
transmitting the at least one message segment to the second device.

16. A method in accordance with claim 15, wherein said transmitting the at least one message segment to the second device comprises executing instructions within a data link layer including a user datagram protocol (UDP) to transmit the at least one message segment to the second device.

17. A method in accordance with claim 15, further comprising forming at least one message fragment from the at least one message segment.

18. A method in accordance with claim 17, wherein said transmitting the at least one message segment to the second device comprises transmitting each message fragment to the second device.

19. A method in accordance with claim 15, further comprising receiving, by the first device, at least one acknowledgement message from the second device when the second device receives the at least one message segment.

20. A method in accordance with claim 19, wherein said determining a quality of the data link comprises determining a number of communication errors detected within a predetermined first amount of time, each communication error is representative of an acknowledgement message that was not properly received within a predetermined second amount of time.
